(19) United States
(12) Patent Application Publication
(10) Pub. No.: US 2012/0196093 A1
(43) Pub. Date: Aug. 2, 2012

(54) METHOD FOR MANUFACTURING A CHAMFERED EDGE AND PLATE SHAPED OBJECT PROVIDED WITH SUCH A CHAMFERED EDGE

(75) Inventors: Kristof Van Vlassenrode, Deinze (BE); Filip Gilbert Lucien Bossuyt, Avelgem (BE)

(73) Assignee: IVC N.V., Avelgem (BE)

(21) Appl. No.: 13/363,911

(22) Filed: Feb. 1, 2012

(30) Foreign Application Priority Data
Feb. 1, 2011 (EP) 11152885.7

(51) Int. Cl. B32B 3/02; B29C 35/08; B29C 37/02; B29C 67/24

(52) U.S. Cl. 428/192; 264/322; 264/492; 264/161

(57) ABSTRACT

A method for manufacturing a chamfered edge with depth d along at least one edge of an upper surface of a plate shaped object, of which at least an upper layer comprises a thermoplastic (or similar) material, comprises the steps of heating the plate shaped object near to said edge; engaging the respective edge of said upper surface with pressure means for forming said chamfered edge by locally displacing material of the upper layer in a downward direction while displacing a substantially corresponding amount of material of the object in a substantially sideward direction outward of the original boundaries of the object; and removing the amount of material which has been displaced outward of the original boundaries of the object. Further a plate shaped object with an upper surface provided with a chamfered edge along at least one of the edges of said upper surface is provided.

### CLAIM OF PRIORITY

This application claims the benefit of priority under 35 U.S.C. §119 (a)-(d) of European Patent Application Serial Number 11152885.7, entitled “METHOD FOR MANUFACTURING A CHAMFERED EDGE AND PLATE SHAPED OBJECT PROVIDED WITH SUCH A CHAMFERED EDGE,” filed on Feb. 1, 2011, the benefit of priority of which is claimed hereby, and which is incorporated by reference herein in its entirety.

### TECHNICAL FIELD

The invention firstly relates to a method for manufacturing a chamfered edge with depth d along at least one edge of an upper surface of a plate shaped object, wherein at least an upper layer of said plate shaped object comprises a thermoplastic (or similar) material.

### BACKGROUND

One important field of application of the present method relates to the manufacture of panels for floors, walls or ceilings. The chamfered edge will give the panel a decorative appearance. A known method for manufacturing such a chamfered edge involves the use of mechanical machining tools for removing chips of material at the location of the chamfered edge.

### BRIEF SUMMARY OF THE INVENTION

It is an object of the present invention to provide an alternative method of the above type.

Thus, in accordance with the present invention a method is provided for manufacturing a chamfered edge with depth d along at least one edge of an upper surface of a plate shaped object, wherein at least an upper layer of said plate shaped object comprises a thermoplastic (or similar) material, which method is characterized by the steps of

a. heating the plate shaped object near to said edge;

b. engaging the respective edge of said upper surface with pressure means for forming said chamfered edge by locally displacing material of the upper layer in a downward direction while displacing a substantially corresponding amount of material of the object in a substantially sideward direction outward of the original boundaries of the object;

c. removing the amount of material which has been displaced outward of the original boundaries of the object.

In contrast to manufacturing a chamfered edge using mechanical machining tools, the present method does not involve the removal of chips of material at the location of the chamfered edge, but at a location well below it. At the location of the chamfered edge itself the material of the upper layer is displaced which yields a chamfered edge with a high quality. Displacing the material is possible because the material is thermoplastic (or is a material with similar properties, such as aplastic with a high content of thermoplastics) and is heated before being displaced.

It is noted that in the present invention the use of terms as “upper”, “downward” et cetera relates to a horizontal position of the plate shaped object in which the layer which is to be provided with the chamfered edge is positioned at the top. During applying the method it is possible however that the plate shaped object assumes a different position, for example with its “upper layer” at the lower side.

In one embodiment of the method according to the present invention, the plate shaped object comprises an upper layer with a thickness less than d and at least an adjoining layer of a thermoplastic (or similar) material, wherein during step a. at least part of the upper layer and at least part of the adjoining layer are heated and wherein during step b. the upper layer is substantially bent downwardly towards and into the adjoining layer while displacing material of the adjoining layer in said substantially sideward direction.

Referring to a specific example of such a plate shaped object, i.e. a floor product (such as a floor tile or floor plank), the upper layer often is a high performance finishing layer (such as, for example, mainly comprising PVC) which has to provide optical and wear resistant qualities. As a result such an upper layer is very expensive and for reducing its cost its thickness should be limited as far as possible and may be as small as 0.2 mm. When a plate shaped object with such a thin upper finishing layer would be provided with a deeper chamfered edge in a conventional manner (using the above mentioned machining tools) the chamfered edge would extend into the adjoining layer which generally is different from the upper layer and which then would become visible. This would negatively influence the aesthetics of the chamfered edge and performance of the floor product, and in most cases it would require additional finishing steps, such as providing an optical lacquer layer and a layer for protecting the adjoining layer against, for example, humidity. Using the method according to the above embodiment, however, allows to manufacture a chamfered edge with a depth which exceeds the thickness of the upper layer (which may be very thin to reduce the overall cost of the object) without making visible the adjoining layer (which often comprises cheaper materials, such as fillers and recycled materials). The upper layer is bent into the adjoining layer for the creation of the chamfered edge, while at the same time displacing material of said adjoining layer. The displaced material of the adjoining layer will be removed during step c. The final chamfered edge has a perfect appearance with a perfectly shaped continuous outer contour.

It is possible then, that the upper layer has a first glass transition temperature and the adjoining layer has a lower second glass transition temperature, wherein during step a, a heating occurs to at least the second glass transition temperature. As a result during engaging the respective edge of said upper surface with pressure means it is ensured that the material of the adjoining layer will be displaced and that the upper layer only will be bent inward without being displaced in any other manner.

In an alternative embodiment of the method according to the present invention, the plate shaped object comprises an upper layer with a thickness more than d and at least one adjoining layer, wherein during step a. at least part of the upper layer is heated and wherein during step b. material of the upper layer more adjacent the adjoining layer is displaced in said substantially sideward direction.

Such an embodiment is useful when, for example, the adjoining layer is not thermoplastic and comprises, for example, wood, wood like materials, duroplast or duroplast like materials. During, carrying out the method this adjoining layer will not deform. However, because the upper layer is sufficiently thick, material of this upper layer near to the adjoining layer may be displaced sidewardly for creating the chamfered edge. During step c. said material originating from the upper edge will be removed.

Among others, the step of heating may occur by infrared heating, by blowing heated air onto the plate shaped object or by positioning a heating member, such as a strip heated to at least 120° C. or alike, against the plate shaped object.

It is possible that the pressure means comprise pressure rolls, pressure shoes or alike. Such pressure means will be positioned and shaped for an optimal engagement of the respective edge of the plate shaped object. There may also be provided multiple pressure means for simultaneously engaging several (or opposite) sides of the plate shaped object for the manufacture of two (or more) chamfered edges at the same time.

In special embodiment of the method the pressure means also act for heating the object. Thus the pressure means may define the sole heating means or may define auxiliary heating means.

Further, in one embodiment, it is possible that the pressure means comprise multiple pressure means with different heating temperatures, for example for gradually heating the respective zone of the plate shaped object.

When during step b. counter pressure means engage strategic positions of the plate shaped object for ensuring that said amount of material of the object is correctly displaced in said substantially sideward direction outward of the original boundaries of the object, an optimal result may be achieved.

Preferably, then, said counter pressure means are applied substantially opposite to each other at the upper and lower sides of the plate shaped object. However, depending on the specific features of the method and depending on the properties of the materials of the plate shaped object, the position of said counter pressure means may be altered.

Said counter pressure means may comprise pressure rolls, pressure shoes or alike.

In an alternative embodiment of the method according to the present invention, after step c. an additional step is carried out of mechanically finishing the chamfered edge. For example it is conceivable that due to material properties (e.g. spring back) of the upper layer the exact manufacture of the chamfered edge solely by the pressure means is not entirely possible and that a final mechanical finishing (such as by milling, grinding, cutting or alike) still will be needed.

The method further may include other steps, such as a final step of cooling the chamfered edge or the additional step of profiling the respective edge of the panel shaped object, for example for manufacturing connecting means.

Preferably all steps are carried out in a continuous manner while trans-porting the plate shaped object in parallel to its edge which is to be provided with the chamfered edge. As a result a high output may be obtained. It should be noted, however, that the method according to the present invention also may be carried out in a step-by-step fashion.

When the method is carried out in a continuous manner, the plate shaped object may be transported along a processing line by means of conveying means such as a conveyor belt, conveyor chain, drive wheels, rollers or alike engaging surfaces of said plate shaped object. Further, for reducing friction and for avoiding damage to the plate shaped object, it is possible that between said conveying means and the respective surfaces of the plate shaped object a protective air cushion is created, for example by using air nozzles.

The method according to the present invention is particularly suited when the upper layer of the plate shaped object comprises a high content of PVC, for example up to 80% PVC. It should be noted, that the present method also is applicable to objects which only comprise one layer of thermoplastic material, e.g., PVC.

In a second aspect the present invention relates to a plate shaped object with an upper surface provided with a chamfered edge along at least one of the edges of said upper surface, which chamfered edge is manufactured using the method according to the present invention.

### BRIEF DESCRIPTION OF THE DRAWINGS

Hereinafter the invention will be elucidated while referring to the drawing, in which:

FIG. 1 shows part of a cross section of a plate shaped object;

FIGS. 2-7 show successive stages during carrying out first embodiment of the method in accordance with the present invention, and

FIG. 8 shows one stage during carrying out a second embodiment of the method in accordance with the present invention.

### DETAILED DESCRIPTION

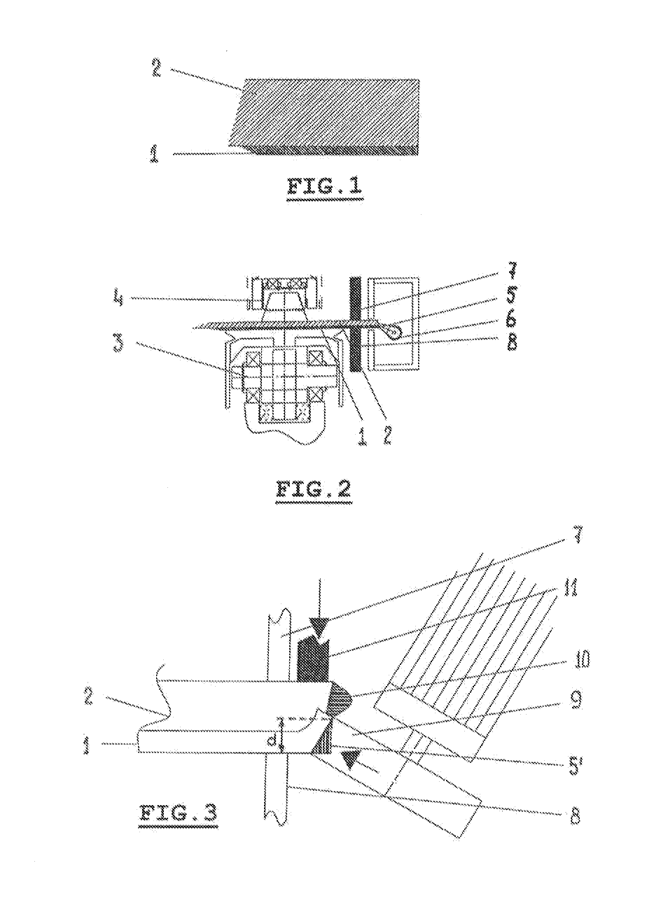

Referring to FIG. 1 part of a cross section of a plate shaped object is shown on a large scale, for example a floor panel. For providing this floor panel with a chamfered edge it will be positioned upside down (as illustrated in the present embodiment) with an upper layer 1 facing downwards, and an adjoining layer 2 facing upwards. The upper layer, for example, may comprise a high content of PVC and is thermoplastic. The adjoining layer likewise is thermoplastic in this embodiment.

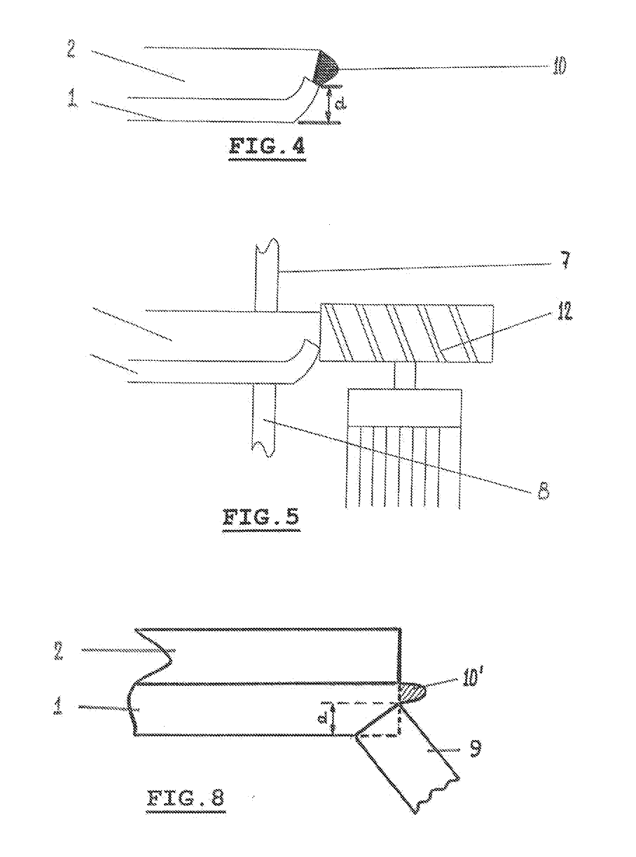

FIG. 2 shows how the floor panel 1,2 is transported upside down along a processing line (comprising stations for carrying out the steps described with respect to FIGS. 2-7) by a conveyor which may comprise a lower chain part 3 and an upper belt part 4. Firstly, the conveyor leads one edge 5 of the floor panel (which is to be provided with the chamfered edge) past a heating member, in this embodiment an infrared heater 6. Positioning means 7 and 8 engage opposite sides of the floor panel for positioning it in a right position while carrying out the method.

As a next step, after heating the floor panel according to the step carried out in FIG. 1, the respective edge 5 of the upper surface of the upper layer 1 of the floor panel is engaged with pressure means 9 for forming the required chamfered edge by locally displacing an amount of material of the upper layer (in FIG. 2 indicated by the dark area 5′) in a downward direction while displacing a substantially corresponding amount of material (indicated in FIG. 2 by the dark area 10) of the adjoining layer 2 in a substantially sideward direction outward of the original boundaries of the panel. One or more counter pressure means is/are provided on strategic positions of the floor panel for ensuring that said amount of material 10 of the adjoining layer 2 is correctly displaced in said substantially sideward direction outward of the original boundaries of the panel.

As appears clearly from FIG. 2, the panel comprises an upper layer 1 with a thickness less than the final depth d of the chamfered edge and an adjoining layer (of a thermoplastic or similar material), wherein during the step of heating at least part of the upper layer 1 and at least part of the adjoining layer 2 are heated. During displacing material the upper layer 1 is substantially bent towards and into the adjoining layer 2 while displacing material (10) of the adjoining layer in said substantially sideward direction.

FIG. 4 shows the floor panel after the displacement of the material. The chamfered edge with depth d has been formed substantially, but the displaced material 10 of the adjoining layer 10 is still bulging out from the panel.

According to FIG. 5 the amount of material 10 which has been displaced outward of the original boundaries of the panel is removed mechanically, such as by milling, grinding, cutting or alike using a removal tool 12. During this removal the floor panel still is supported by the positioning means 7,8.

Referring back to FIG. 4, one can see that the outer surface of the chamfered edge is not completely straight, as may happen due to phenomena such as spring back of the material of the upper layer 1. Thus, if a fully straight outer surface is required, a finishing step of the chamfered edge may be carried out, as represented in FIG. 6 which shows a machining tool 13 acting on said outer surface.

FIG. 7, finally, shows a further tool 14 which will be used for profiling the side of the floor panel, for example for creating a connecting means (such as part of a snap connection).

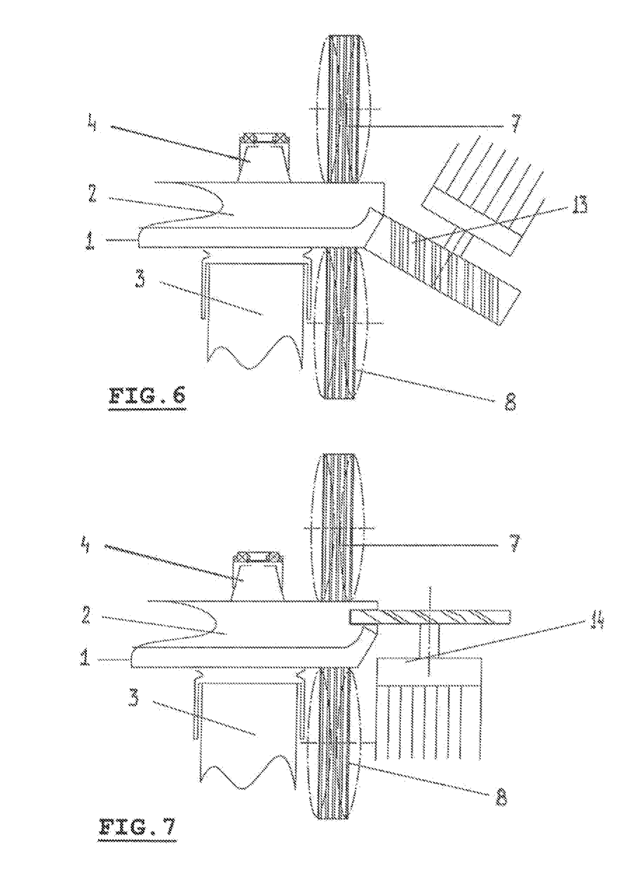

FIG. 8 illustrates part of an alternative embodiment of the method according to the invention which may be used when the plate shaped object comprises an upper layer 1 with a thickness more than d and an adjoining layer 2 which in this case does not need to be thermoplastic, in this embodiment, during heating only part of the upper layer needs to be heated. When engaging the respective edge of the upper surface of the upper layer 1 with a pressure means 9 thr forming said chamfered edge, material of the upper layer 1 adjacent the adjoining layer 2 is displaced in said substantially sideward direction and forms an amount of displaced material 10′ which thereafter (in correspondence with FIG. 5) will be removed. The remaining steps are equivalent with the steps described with respect to the embodiment according to FIGS. 1-7.

The invention is not limited to the embodiments described before which may be varied widely within the scope of the invention as defined by the appending claims. Thus it is also possible to provide a chamfered edge in a plate shaped object which comprises only one single thermoplastic layer. Further it is conceivable that more than one chamfered edge is manufactured at the same time, for example at two opposite sides of the object. Finally it is noted that, although the plate shaped object in accordance with the embodiments described before comprises only two layers, such a plate shaped object also may comprise more layers, as is known per se for example in the field of floor products (such as floor tiles or floor planks).

What is claimed is:

1. A method for manufacturing a chamfered edge with depth d along at least one edge of an upper surface of a plate shaped object, wherein at least an upper layer of said plate shaped object comprises a thermoplastic (or similar) material, the method comprising:
a. heating the plate shaped object near to said edge;
b. engaging the respective edge of said upper surface with pressure means for forming said chamfered edge by locally displacing material of the upper layer in a downward direction while displacing a substantially corresponding amount of material of the object in a substantially sideward direction outward of the original boundaries of the object; and
c. removing the amount of material which has been displaced outward of the original boundaries of the object.

2. The method according to claim 1, wherein the plate shaped object comprises an upper layer with a thickness less than d and at least an adjoining layer of a thermoplastic (or similar) material, wherein during step a. at least part of the upper layer and at least part of the adjoining layer are heated and wherein during step b. the upper layer is substantially bent downwardly towards and into the adjoining layer while displacing material of the adjoining layer in said substantially sideward direction.

3. The method according to claim 2, wherein the upper layer has a first glass transition temperature and the adjoining layer has a lower second glass transition temperature and wherein during step a. a heating occurs to at least second glass transition temperature.

4. The method according to claim 1, wherein the plate shaped object comprises an upper layer with a thickness more than d and at least one adjoining layer, wherein during step a. at least part of the upper layer is heated and wherein during step b. material of the upper layer more adjacent the adjoining layer is displaced in said substantially sideward direction.

5. The method according to claim 4, wherein the adjoining layer is not thermoplastic, and comprises, for example, wood, wood like materials, duroplast or duroplast like materials.

6. The method according to claim 1, wherein the step of heating occurs by infrared heating.

7. The method according to claim 1, wherein the step of heating occurs by blowing heated air onto the plate shaped object.

8. The method according to claim 1, wherein the step of heating occurs by positioning a heating member, such as a strip heated to at least 120° C. or alike, against the plate shaped object.

9. The method according to claim 1, wherein the pressure means comprise pressure rolls, pressure shoes or alike.

10. The method according to claim 9, wherein the pressure means also act for heating the object.

11. The method according to claim 10, wherein the pressure means comprise multiple pressure means with different heating temperatures.

12. The method according to claim 1, wherein during step b. counter pressure means engage strategic positions of the plate shaped object for ensuring that said amount of material of the object is correctly displaced in said substantially sideward direction outward of the original boundaries of the object.

13. The method according to claim 12, wherein said counter pressure means are applied substantially opposite to each other at the upper and lower sides of the plate shaped object.

14. The method according to claim 12, wherein said counter pressure means comprise pressure rolls, pressure shoes or alike.

15. The method according to claim 1, wherein after step c. an additional step is carried out of mechanically finishing the chamfered edge.

16. The method according to claim 1, wherein step c. is carried out mechanically, such as by milling, grinding, cutting or alike.

17. The method according to claim 1, comprising a final step of cooling the chamfered edge.

18. The method according to claim 1, comprising the additional step of profiling the respective edge of the panel shaped object, for example for manufacturing connecting means.

19. The method according to claim 1, wherein all steps are carried out in a continuous manner while transporting the plate shaped object in parallel to its edge which is to be provided with the chamfered edge.

20. The method according to claim 19, wherein the plate shaped object is transported along a processing line by means of conveying means such as a conveyor belt, conveyor chain, drive wheels, rollers or alike engaging surfaces of said plate shaped object.

21. The method according to claim 20, wherein between said conveying means and the respective surfaces of the plate shaped object a protective air cushion is created.

22. The method according to claim 1, wherein the upper layer of the plate shaped object comprises a high content of PVC.

23. A plate shaped object with an upper surface provided with a chamfered edge along at least one of the edges of said upper surface, which chamfered edge is manufactured using the method according to claim 1.
